(19) United States
(12) Patent Application Publication
(10) Pub. No.: US 2025/0046793 A1
(43) Pub. Date: Feb. 6, 2025

(54) BATTERY

(71) Applicant: FDK CORPORATION, Tokyo (JP)

(72) Inventors: Hidenori TSUZUKI, Tokyo (JP); Shigeyuki KUNIYA, Tokyo (JP)

(73) Assignee: FDK CORPORATION, Tokyo (JP)

(21) Appl. No.: 18/921,933

(22) Filed: Oct. 21, 2024

Related U.S. Application Data
(63) Continuation of application No. PCT/JP2023/007746, filed on Mar. 2, 2023.

(30) Foreign Application Priority Data
Apr. 27, 2022 (JP) 2022-072987

(51) Int. Cl. H01M 4/36; H01M 4/02; H01M 4/06; H01M 4/24; H01M 6/18

(52) U.S. Cl. CPC H01M 4/364; H01M 4/06; H01M 4/244; H01M 6/181; H01M 2004/021; H01M 2004/027; H01M 2300/0082

(57) ABSTRACT

A battery includes a cathode that is containing manganese dioxide and graphite, an anode that is containing zinc, an electrolyte in which the cathode and the anode are immersed, and a polyethyleneimine ethoxylate that is contained in the anode or in the electrolyte.

### CROSS-REFERENCE TO RELATED APPLICATION

This application is a continuation of International Application No. PCT/JP2023/007746, filed on Mar. 2, 2023 which claims the benefit of priority of the prior Japanese Patent Application No. 2022-072987, filed on Apr. 27, 2022, the entire contents of which are incorporated herein by reference.

### FIELD

The embodiment discussed herein is related to a battery.

### BACKGROUND

Alkaline dry cells having a surfactant added to an anode have been known (Japanese Laid-open Patent Publication No. 2017-069097 and Japanese Laid-open Patent Publication No. 2019-160786). The alkaline dry cell like these can suppress generation of a hydrogen gas thereby preventing leakage and can improve a discharge performance with a heavy load.

However, the alkaline dry cell may decrease a discharge performance with a medium load when a surfactant is added to an anode.

### SUMMARY

According to an aspect of an embodiment, a battery includes a cathode that is containing manganese dioxide and graphite, an anode that is containing zinc, an electrolyte in which the cathode and the anode are immersed, and a polyethyleneimine ethoxylate that is contained in the anode and in the electrolyte.

According to another aspect of an embodiment, a battery includes a cathode that is containing manganese dioxide and graphite, an anode that is containing zinc, an electrolyte in which the cathode and the anode are immersed, and a polyethyleneimine ethoxylate that is contained in the anode.

According to still another aspect of an embodiment, a battery includes a cathode that is containing manganese dioxide and graphite, an anode that is containing zinc, an electrolyte in which the cathode and the anode are immersed, and a polyethyleneimine ethoxylate that is contained in the electrolyte.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is a perspective cross-sectional view of an embodiment of a battery; and

FIG. 2 is a flowchart of a production method of producing the battery.

### DESCRIPTION OF EMBODIMENTS

Preferred embodiments of the disclosure will be described with reference to accompanying drawings. However, it is noted that the technology in the present disclosure shall not be limited by the description below. In the description below, identical elements are given the same symbol, so that a duplicated explanation will be omitted.

### Battery 1 of Embodiment

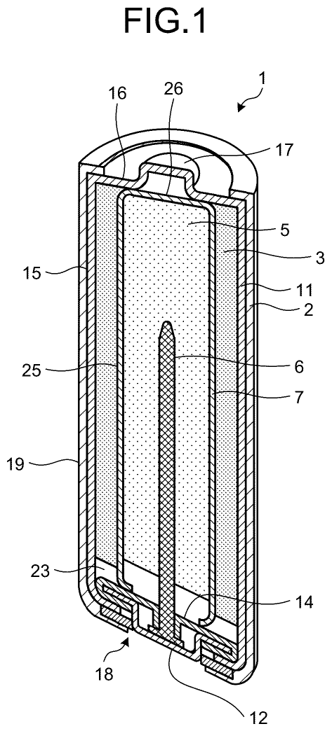

A battery 1 of the embodiment is an alkaline dry cell, which is equipped, as illustrated in FIG. 1, with a battery case 2, a cathode 3, an anode 5, a current collecting rod 6, and a separator 7. FIG. 1 is a perspective cross-sectional view of the battery 1 of the embodiment. The battery case 2 has a cathode can 11, an anode terminal plate 12, and a sealing gasket 14. The cathode can 11 is formed of a conductor that is exemplified by a metal. The cathode can 11 is formed in a cylindrical shape with a bottom and has a side portion 15 and a bottom portion 16. The side portion 15 is formed of a curved plate that is curved along the side of the cylindrical column. The bottom portion 16 is arranged along one bottom surface of the cylindrical column. The bottom portion 16 is integrally connected to the side portion 15 such that the edge of the bottom portion 16 will adjoin one end of the side portion 15.

In the bottom portion 16, a convexoconcave is formed, and a cathode terminal portion 17 is formed in the center of the bottom portion 16. The cathode terminal portion 17 is formed such that it will protrude outward from the inside of the cathode can 11. The cathode can 11 has an opening 18. The opening 18 is formed in the portion corresponding to the other bottom of the cylindrical column in the side portion 15. The inside of the cathode can 11 is connected to the outside of the cathode can 11 via the opening 18.

The anode terminal plate 12 is formed of a conductor that is exemplified by a metal and has roughly a disk shape. The anode terminal plate 12 is arranged along the other bottom of the cylindrical column. Inside the battery case 2, the anode terminal plate 12 is arranged along the other bottom of the cylindrical column, so that an inner space 23 surrounded by the cathode can 11 and the anode terminal plate 12 is formed.

The sealing gasket 14 is formed of an insulating material that is exemplified by a resin and has roughly a ring shape. The sealing gasket 14 surrounds the edge of the anode terminal plate 12 and is arranged at the opening 18 of the cathode can 11. The sealing gasket 14 is interposed between the edge of the anode terminal plate 12 and the cathode can 11 to seal the gap formed between the edge of the anode terminal plate 12 and the cathode can 11. Owing to the sealing gasket 14 that is interposed between the edge of the anode terminal plate 12 and the cathode can 11, the anode terminal plate 12 is fixed to the cathode can 11 via the sealing gasket 14. Because the sealing gasket 14 is interposed between the edge of the anode terminal plate 12 and the cathode can 11, the anode terminal plate 12 is electrically insulated from the cathode can 11 by the sealing gasket 14.

The battery case 2 is further provided with an outer label 19. The outer label 19 is formed of a heat-shrinkable film. The heat-shrinkable film is an insulator and shrinks when heated. The outer label 19 covers the area of the surface exposed to the outside of the battery case 2, excluding the area of the anode terminal plate 12 and the cathode terminal portion 17.

The cathode 3 is formed of a cathode mixture, containing a cathode active material, a binder, and a potassium hydroxide aqueous solution (electrolyte). The cathode active material contains manganese dioxide MnO₂ and graphite C. The binder contains, for example, a polymer compound that adheres the powders formed of the cathode active material to each other to form a solid. The cathode 3 is formed in a tubular shape and is arranged in the inner space 23 of the battery case 2. The cathode 3 intimately contacts with the inner surface of the side portion 15 of the cathode can 11 so that the cathode active material is electrically connected to the cathode can 11.

The anode 5 is formed of an anode active material and is gelatinous. The anode active material contains a zinc powder, a potassium hydroxide aqueous solution (electrolyte), and a sodium polyacrylate. The anode 5 further contains a polyethyleneimine ethoxylate. The anode 5 is arranged in an inner side of the cathode 3 in the inner space 23 of the battery case 2. The zinc powder in the anode active material may be replaced by a zinc alloy powder formed of a zinc alloy containing zinc.

The current collecting rod 6 is formed of a conductor and has a rod shape. The current collecting rod 6 is disposed in the inner space 23 along the central axis of the cylindrical column along which the side portion 15 is aligned. The current collecting rod 6 is further embedded into the anode 5 so that the current collecting rod 6 is electrically connected to the zinc powder of the anode 5. The current collecting rod 6 further goes through the center of the sealing gasket 14. Moreover, one end of the current collecting rod 6 is bonded to the anode terminal plate 12 so that the current collecting rod 6 is fixed to the anode terminal plate 12 thereby being electrically connected to the anode terminal plate 12.

The separator 7 is formed of an insulator that is exemplified by vinylon or pulp. The separator 7 is formed in the shape of a hollow cylinder with a bottom and has a side portion 25 and a bottom portion 26. The side portion 25 is arranged between the cathode 3 and the anode 5 in the inner space 23. The bottom portion 26 is arranged between the anode 5 and the bottom portion 16 of the cathode can 11 in the inner space 23. The bottom portion 26 is integrally connected to one end of the side portion 25 such that the area of the inner space 23 in which the anode 5 is disposed will be separated from the area of the inner space 23 in which the cathode 3 and the cathode can 11 are disposed. The separator 7, thus disposed, separates the cathode 3 from the anode 5, and the anode 5 from the cathode can 11. The anode 5 is electrically insulated from the cathode 3 by the separator 7 that separates the cathode 3 from the anode 5, and is electrically insulated from the cathode can 11 by the separator 7 that separates the anode 5 from the cathode can 11.

The battery 1 is further provided with an electrolyte. The electrolyte is formed of an aqueous solution containing potassium hydroxide KOH. The electrolyte further contains the polyethyleneimine ethoxylate. The ratio of the sum of the masses of the polyethyleneimine ethoxylate contained in the anode 5 and in the electrolyte to the mass of the zinc contained in the anode 5 is 10 ppm or more and 10000 ppm or less. The electrolyte is arranged in the inner space 23 such that the cathode 3 and the anode 5 will be immersed in the electrolyte, thereby penetrating into the separator 7 and the cathode 3.

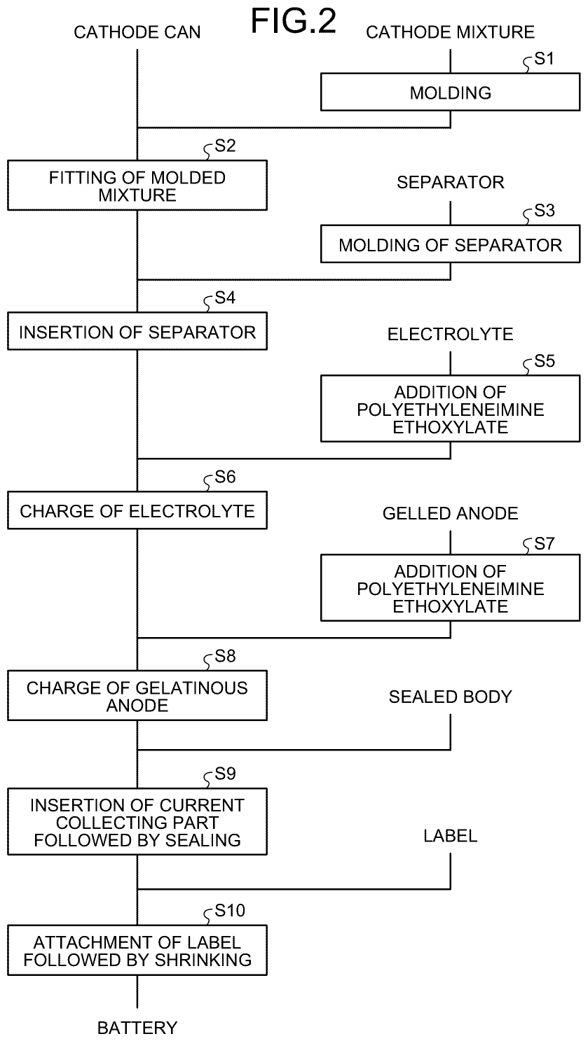

FIG. 2 illustrates a flowchart of the production method of producing the battery 1. In the production method of the battery, the cathode mixture is prepared, and the cathode can 11 is prepared. The cathode mixture is molded (Step S1) to form the cathode 3. The cathode 3 is inserted into the cathode can 11 such that the cathode 3 will fit to the cathode can 11, i.e., the outer circumference of the cathode 3 will contact the inner circumference of the cathode can 11 (Step S2).

In the production method of the battery, the separator 7 is further prepared. The separator 7 is molded (Step S3) to form a hollow cylindrical shape with a bottom. After the cathode 3 is inserted into the cathode can 11 and after the separator 7 is molded to the hollow cylindrical shape with the bottom, the separator 7 is inserted into the cathode 3 (Step S4).

In the production method of the battery, the electrolyte is further prepared. The electrolyte is prepared as an aqueous solution in which potassium hydroxide KOH is dissolved at a predetermined concentration. A predetermined amount of the polyethyleneimine ethoxylate is added to the electrolyte (Step S5). The process of Step S5 may be omitted when the polyethyleneimine ethoxylate is added to the anode 5. After the separator 7 is inserted into the cathode 3, the electrolyte is charged inside the cathode 3 (Step S6). By charging the electrolyte inside the cathode 3, the electrolyte penetrates into the separator 7 and into the cathode 3.

In the production method of the battery, the anode 5 is further prepared. The anode 5 is prepared as a gelatinous form by mixing a predetermined amount of the zinc powder, a predetermined amount of the electrolyte (potassium hydroxide aqueous solution), and a predetermined amount of the sodium polyacrylate. The anode 5 is further added with a predetermined amount of the polyethyleneimine ethoxylate (Step S7). The process of Step S7 may be omitted in the case when the polyethyleneimine ethoxylate is added to the electrolyte. After the electrolyte has penetrated into the separator 7 and the cathode 3, a predetermined amount of the anode 5 is charged inside the separator 7 (Step S8).

In the production method of the battery, the current collecting rod 6, the anode terminal plate 12, and the sealing gasket 14 are further prepared. A sealed body is formed by joining the current collecting rod 6 to the anode terminal plate 12 such that the current collecting rod 6 will be electrically contacted with the anode terminal plate 12 and also by joining the sealing gasket 14 to the anode terminal plate 12 such that the edge of the anode terminal plate 12 will be covered with the sealing gasket 14. After the anode 5 is charged, the sealed body is attached to the cathode can 11 such that the current collecting rod 6 joined to the anode terminal plate 12 will be embedded in the anode 5 and that the anode terminal plate 12 and the sealing gasket 14 will close the opening 18. After the sealed body is attached to the cathode can 11, the portion around the opening 18 of the cathode can 11 is swaged such that the gap formed between the anode terminal plate 12 and the cathode can 11 will be sealed by the sealing gasket 14 (Step S9). By swaging the cathode can 11, the sealing gasket 14 is deformed, the sealed body is fixed to the cathode can 11, and the inner space 23 is sealed from the outside.

In the production method of the battery, the outer label 19 is further prepared. After the current collecting rod 6, the anode terminal plate 12, and the sealing gasket 14 are fixed to the cathode can 11, the outer label 19 is wrapped around the battery case 2 such that the area of the surface of the battery case 2, except for the anode terminal plate 12 and the cathode terminal portion 17, will be covered (Step S10). After the outer label 19 is wrapped around the battery case 2, the outer label 19 is heated, shrunk, and affixed to the battery case 2 to produce the battery 1. According to the production method of the battery described above, the battery 1 may be properly fabricated in such a way that the polyethyleneimine ethoxylate will be properly added to the anode 5 or to the electrolyte.

### Evaluation Test of the Battery 1

To verify the effectiveness of the battery 1 of the embodiment, multiple battery samples have been fabricated and a continuous discharge test with a medium load has been performed on each of the battery samples. Table 1 summarizes multiple fabrication conditions and results of the multiple continuous discharge tests with a medium load, corresponding to these battery samples.

TABLE 1

| | Comparative | Comparative | Comparative | Exam- | Exam- | Exam- | Exam- | Exam- | Exam- |
|---|---|---|---|---|---|---|---|---|---|
| | Example 1 | Example 2 | Example 3 | ple 1 | ple 2 | ple 3 | ple 4 | ple 5 | ple 6 |
| Additive | None | Sodium | Alcohol | Polyethyleneimine ethoxylate | | | | | |
| | | alkylbenzene | ethoxylate | | | | | | |
| | | sulfonate | | | | | | | |
| Addition | 0 | 100 | 100 | 5 | 10 | 100 | 1000 | 10000 | 50000 |
| amount | | | | | | | | | |
| (ppm/Zn) | | | | | | | | | |
| Result of | 100 | 95 | 105 | 105 | 125 | 140 | 140 | 130 | 100 |
| continuous | | | | | | | | | |
| discharge | | | | | | | | | |
| test with | | | | | | | | | |
| medium load | | | | | | | | | |

These battery samples include a battery of Comparative Example 1, a battery of Comparative Example 2, a battery of Comparative Example 3, a battery of Example 1, a battery of Example 2, a battery of Example 3, a battery of Example 4, a battery of Example 5, and a battery of Example 6.

These battery samples are fabricated such that the fabrication conditions are different from each other. The fabrication conditions are indicated by the additive and the addition amount thereof. The additive indicates the surfactant added to the anode 5 or to the electrolyte; and they are specifically “polyethyleneimine ethoxylate”, “sodium alkylbenzenesulfonate”, “alcohol ethoxylate”, or “none”. Namely, when the additive corresponding to a certain battery sample indicates “polyethyleneimine ethoxylate”, it indicates that the polyethyleneimine ethoxylate is added to the anode 5 or to the electrolyte of this certain battery sample. When the additive corresponding to a certain battery sample indicates “sodium alkylbenzenesulfonate”, it indicates that the sodium alkylbenzenesulfonate is added to the anode 5 or to the electrolyte of this certain battery sample, and that the polyethyleneimine ethoxylate is not added to the anode 5 and to the electrolyte of this certain battery sample. When the additive corresponding to a certain battery sample indicates “alcohol ethoxylate”, it indicates that the alcohol ethoxylate is added to the anode 5 or to the electrolyte of this certain battery sample, and that the polyethyleneimine ethoxylate is not added to the anode 5 and to the electrolyte of this certain battery sample. When the additive corresponding to a certain battery sample indicates “none”, it indicates that the surfactant that is exemplified by the polyethyleneimine ethoxylate, the sodium alkylbenzenesulfonate, and the alcohol ethoxylate is not added to the anode 5 and to the electrolyte of this certain battery sample.

The addition amount corresponding to a certain battery sample represents the total amount of the surfactant added to the anode 5 and to the electrolyte of this certain battery sample, and is indicated by the ratio of the total amount of the surfactant added to the anode 5 and to the electrolyte of this certain battery sample to the mass of the zinc contained in the anode 5 of this certain battery sample. Namely, when the addition amount corresponding to a certain battery sample indicates “X ppm/Zn”, this means that the value obtained by dividing the mass of the surfactant added to the anode 5 and to the electrolyte of this certain battery sample by the mass of the zinc contained in the anode 5 of this certain battery sample followed by multiplying with one million is equal to the value of X.

These battery samples are all fabricated in the same way, except that their fabrication conditions are different from each other. Namely, in these battery samples, the cathode 3, the current collecting rod 6, the separator 7, the cathode can 11, the anode terminal plate 12, and the sealing gasket 14 are fabricated so as to give the battery size of LR14 (size C battery).

The additive to the battery in Comparative Example 1 is described as “none”. The addition amount thereof added to the battery in Comparative Example 1 is described as “0 ppm/Zn”. Namely, the battery in Comparative Example 1 is fabricated in such a way that no surfactant is added to the anode 5 and to the electrolyte.

The additive to the battery in Comparative Example 2 is described as “sodium alkylbenzenesulfonate”. The addition amount thereof added to the battery in Comparative Example 2 is described as “100 ppm/Zn”. Namely, the battery in Comparative Example 2 is fabricated in such a way that 100 ppm of the sodium alkylbenzenesulfonate relative to the zinc contained in the anode 5 is added to the anode 5 and to the electrolyte.

The additive for the battery in Comparative Example 3 is described as “alcohol ethoxylate”. The addition amount thereof to the battery in Comparative Example 3 is described as “100 ppm/Zn”. Namely, the battery in Comparative Example 3 is fabricated in such a way that 100 ppm of the alcohol ethoxylate relative to the zinc contained in the anode 5 is added to the anode 5 and to the electrolyte.

The additive for the battery in Example 1 is described as “polyethyleneimine ethoxylate”. The addition amount thereof added to the battery in Example 1 is described as “5 ppm/Zn”. Namely, the battery in Example 1 is fabricated in such a way that 5 ppm of the polyethyleneimine ethoxylate relative to the zinc contained in the anode 5 is added to the anode 5 and to the electrolyte.

The additive to the battery in Example 2 is described as “polyethyleneimine ethoxylate”. The addition amount thereof added to the battery in Example 2 is described as “10 ppm/Zn”. Namely, the battery in Example 2 is fabricated in such a way that 10 ppm of the polyethyleneimine ethoxylate relative to the zinc contained in the anode 5 is added to the anode 5 and to the electrolyte.

The additive for the battery in Example 3 is described as “polyethyleneimine ethoxylate”. The addition amount thereof added to the battery in Example 3 is described as “100 ppm/Zn”. Namely, the battery in Example 3 is fabricated in such a way that 100 ppm of the polyethyleneimine ethoxylate relative to the zinc contained in the anode 5 is added to the anode 5 and to the electrolyte.

The additive for the battery in Example 4 is described as “polyethyleneimine ethoxylate”. The addition amount thereof added to the battery in Example 4 is described as “1000 ppm/Zn”. Namely, the battery in Example 4 is fabricated in such a way that 1000 ppm of the polyethyleneimine ethoxylate relative to the zinc contained in the anode 5 is added to the anode 5 and to the electrolyte.

The additive for the battery in Example 5 is described as “polyethyleneimine ethoxylate”. The addition amount thereof added to the battery in Example 5 is described as “10000 ppm/Zn”. Namely, the battery in Example 5 is fabricated in such a way that 10000 ppm of the polyethyleneimine ethoxylate relative to the zinc contained in the anode 5 is added to the anode 5 and to the electrolyte.

The additive for the battery in Example 6 is described as “polyethyleneimine ethoxylate”. The addition amount thereof added to the battery in Example 6 is described as “50000 ppm/Zn”. Namely, the battery in Example 6 is fabricated in such a way that 50000 ppm of the polyethyleneimine ethoxylate relative to the zinc contained in the anode 5 is added to the anode 5 and to the electrolyte.

The result of the continuous discharge test with a medium load corresponding to a certain battery sample among the results of the continuous discharge tests with a medium load is obtained by performing the continuous discharge test with a medium load on this certain battery sample. In the continuous discharge test with a medium load performed on a certain battery sample, this certain battery sample is electrically connected to a 3.9Ω load to obtain the continuous discharge time with a medium load. The continuous discharge time with a medium load indicates the duration time that the battery sample has been discharged before its battery voltage becomes less than a termination voltage of 0.8 V.

The result of the continuous discharge test with a medium load corresponding to a certain battery sample among the results of the continuous discharge tests with a medium load indicates the value that is obtained by dividing the average continuous discharge time with a medium load for this certain battery sample by the average continuous discharge time with a medium load for the battery in Comparative Example 1 followed by multiplying with 100. The average continuous discharge time with a medium load for this certain battery sample represents the average of the continuous discharge times with a medium load obtained in multiple batteries fabricated for this certain battery sample. The results of the continuous discharge tests with a medium load indicate that the battery sample corresponding to a larger value in the result of the continuous discharge test with a medium load exhibits a better discharge performance with a medium load.

Of the results of the continuous discharge tests with a medium load, the result of the continuous discharge test with a medium load corresponding to the battery in Comparative Example 1 indicates 100, the result of the continuous discharge test with a medium load corresponding to the battery in Comparative Example 2 indicates 95, and the result of the continuous discharge test with a medium load corresponding to the battery in Comparative Example 3 indicates 105. The results of the continuous discharges tests with a medium load indicate that the results of the continuous discharge tests for the batteries in Comparative Examples 2 to 3 are almost equivalent to the result of the continuous discharge test with a medium load for the battery in Comparative Example 1, and that the discharge performances with a medium load for the batteries in Comparative Examples 2 to 3 are almost equivalent to the performance with a medium load for the battery in Comparative Example 1. Namely, the results of the continuous discharge tests with a medium load indicate that the addition of a surfactant other than the polyethyleneimine ethoxylate to the anode 5 and to the electrolyte of the battery does not significantly improve the battery's discharge performance with a medium load as compared to the batteries in which no surfactant is added to the anode 5 and to the electrolyte.

Of the results of the continuous discharge tests with a medium load, the result of the continuous discharge test with a medium load corresponding to the battery in Example 1 indicates 105, the result of the continuous discharge test with a medium load corresponding to the battery in Example 2 indicates 125, and the result of the continuous discharge test with a medium load corresponding to the battery in Example 3 indicates 140. Of the results of the continuous discharge tests with a medium load, the result of the continuous discharge test with a medium load corresponding to the battery in Example 4 indicates 140, the result of the continuous discharge test with a medium load corresponding to the battery in Example 5 indicates 130, and the result of the continuous discharge test with a medium load corresponding to the battery in Example 6 indicates 100.

In the results of the continuous discharge tests with a medium load, the results of the continuous discharge tests with a medium load for the batteries in Examples 1 to 6 are more than the result of the continuous discharge test with a medium load for the battery in Comparative Example 2, indicating that the discharge performances with a medium load for the batteries in Examples 1 to 6 are better than the discharge performance with a medium load for the battery in Comparative Example 2. Namely, the results of the continuous discharge tests with a medium load indicate that the discharge performance with a medium load for the batteries in which the polyethyleneimine ethoxylate is added to the anode 5 and to the electrolyte is better than the discharge performance with a medium load of the battery in which the sodium alkylbenzenesulfonate is added to the anode 5 and to the electrolyte.

The results of the continuous discharge tests with a medium load indicate that the results of the continuous discharge tests for the batteries in Examples 2 to 5 are more than the result of the continuous discharge test with a medium load for the battery in Comparative Example 3, indicating that the discharge performances with a medium load for the batteries in Examples 2 to 5 are better than the discharge performance with a medium load for the battery in Comparative Example 3. Namely, the results of the continuous discharge tests with a medium load indicate that the discharge performance with a medium load for the batteries having the polyethyleneimine ethoxylate added to the anode 5 and to the electrolyte with amounts of 10 ppm/Zn or more and 10000 ppm/Zn or less is better than the discharge performance with a medium load for the battery having the alcohol ethoxylate added to the anode 5 and to the electrolyte.

The results of the continuous discharge tests with a medium load indicate that the results of the continuous discharge tests for the batteries in Examples 1 to 5 are more than the result of the continuous discharge test with a medium load for the battery in Comparative Example 1, indicating that the discharge performances with a medium load for the batteries in Examples 1 to 5 are better than the discharge performance with a medium load for the battery in Comparative Example 1. Namely, the results of the continuous discharge tests with a medium load indicate that the discharge performance with a medium load for the batteries having the polyethyleneimine ethoxylate added to the anode 5 and to the electrolyte with amounts of 5 ppm/Zn or more and 10000 ppm/Zn or less is better than the discharge performance with a medium load for the battery not having the surfactant added to the anode 5 and to the electrolyte.

The results of the continuous discharge tests with a medium load indicate that the results of the continuous discharge tests for the batteries in Examples 3 and 4 are more than the results of the continuous discharge tests with a medium load for the batteries in Examples 1 and 2. The results of the continuous discharge tests with a medium load indicate that when the mass ratio of the polyethyleneimine ethoxylate relative to the mass of the zinc is less than 100 ppm/Zn, the discharge performance of the battery with a medium load tends to become lower as the amount of the polyethyleneimine ethoxylate decreases.

The results of the continuous discharge tests with a medium load indicate that the results of the continuous discharge tests for the batteries in Examples 3 and 4 are more than the results of the continuous discharge tests with a medium load for the batteries in Examples 5 and 6. The results of the continuous discharge tests with a medium load indicate that when the mass ratio of the polyethyleneimine ethoxylate relative to the mass of the zinc is more than 1000 ppm/Zn, the discharge performance of the battery with a medium load tends to become lower as the amount of the polyethyleneimine ethoxylate increases.

To confirm the effectiveness of the battery 1 of the embodiment, a drop test is further performed on each of the battery samples. Table 2 summarizes multiple fabrication conditions and results of the multiple drop tests corresponding to multiple battery samples.

TABLE 2

| | Comparative | Exam- | Exam- | Exam- | Exam- | Exam- | Exam- | Exam- | Exam- | Exam- | Exam- |
|---|---|---|---|---|---|---|---|---|---|---|---|
| | Example 4 | ple 7 | ple 8 | ple 9 | ple 10 | ple 11 | ple 12 | ple 13 | ple 14 | ple 15 | ple 16 |
| Additive | None | Polyethyleneimine ethoxylate | | | | | | | | | |
| Addition | 0 | 100 | 100 | 100 | 100 | 100 | 100 | 100 | 100 | 100 | 100 |
| amount | | | | | | | | | | | |
| (ppm/Zn) | | | | | | | | | | | |
| Na-PA | 120 | 30 | 50 | 120 | 300 | 500 | 120 | 120 | 120 | 120 | 120 |
| average | | | | | | | | | | | |
| particle | | | | | | | | | | | |
| diameter | | | | | | | | | | | |
| (μm) | | | | | | | | | | | |
| Na-PA | 1.0 | 1.5 | 1.5 | 1.5 | 1.5 | 1.5 | 0.7 | 1.0 | 1.5 | 2.0 | 2.5 |
| addition | | | | | | | | | | | |
| amount | | | | | | | | | | | |
| (%/EL) | | | | | | | | | | | |
| Result of | 0.00 | 0.03 | 0.01 | 0.00 | 0.00 | Unfabricable | 0.04 | 0.01 | 0.00 | 0.00 | Unfabricable |
| drop test | | | | | | | | | | | |
| (V) | | | | | | | | | | | |

These battery samples include a battery of Comparative Example 4, a battery of Example 7, a battery of Example 8, a battery of Example 9, a battery of Example 10, a battery of Example 11, a battery of Example 12, a battery of Example 13, a battery of Example 14, a battery of Example 15, and a battery of Example 16. These battery samples are fabricated such that the fabrication conditions are different from each other. The fabrication conditions are indicated by the additive, the addition amount thereof, the Na-PA average particle diameter, and the Na-PA addition amount. The additive for a certain battery sample is the surfactant added to the anode 5 or to the electrolyte of this certain battery sample, similarly to the additives described in Table 1. The addition amount of the surfactant for a certain battery sample is the amount of the surfactant added to the anode 5 or to the electrolyte of this certain battery sample, similarly to the addition amount described in Table 1.

The Na-PA average particle diameter for a certain battery sample represents the average particle diameter of the sodium polyacrylate contained in the anode 5 of this certain battery sample. The Na-PA addition amount corresponding to a certain battery sample indicates the amount of the sodium polyacrylate contained in the anode 5 of this certain battery sample, and indicates the ratio of the mass of the sodium polyacrylate added to the anode 5 of this certain battery sample to the mass of the electrolyte (EL) contained in the anode 5 of this certain battery sample. Namely, when the Na-PA addition amount corresponding to a certain battery sample indicates “Y %/EL”, this means that the value obtained by dividing the mass of the sodium polyacrylate added to the anode 5 of this certain battery sample by the mass of the electrolyte contained in the anode 5 of this certain battery sample followed by multiplying with 100 is equal to the value of Y.

These battery samples are all fabricated in the same way, except that their fabrication conditions are different from each other. Namely, in these battery samples, the cathode 3, the current collecting rod 6, the separator 7, the cathode can 11, the anode terminal plate 12, and the sealing gasket 14 are fabricated so as to give the battery size of LR14 (size C battery).

The additive to the battery in Comparative Example 4 is described as “none”. The addition amount thereof added to the battery in Comparative Example 4 is described as “0 ppm/Zn”. The Na-PA average particle diameter of the battery in Comparative Example 4 is described as “120 μm”. The Na-PA addition amount added to the battery in Comparative Example 4 is described as “1.0%/EL”. Namely, the battery in Comparative Example 4 is fabricated in such a way that no surfactant is added to the anode 5 and to the electrolyte, and that only 1.0%/EL of the sodium polyacrylate with an average particle diameter of 120 μm is contained in the anode 5.

The additive to the battery in Example 7 is described as “polyethyleneimine ethoxylate”. The addition amount thereof added to the battery in Example 7 is described as “100 ppm/Zn”. The Na-PA average particle diameter of the battery in Example 7 is described as “30 μm”. The Na-PA addition amount added to the battery in Example 7 is described as “1.5%/EL”. Namely, the battery of Example 7 is fabricated in such a way that 100 ppm/Zn of the polyethyleneimine ethoxylate is added to the anode 5 and to the electrolyte, and that only 1.5%/EL of the sodium polyacrylate with an average particle diameter of 30 μm is contained in the anode 5.

The additive to the battery in Example 8 is described as “polyethyleneimine ethoxylate”. The addition amount thereof added to the battery in Example 8 is described as “100 ppm/Zn”. The Na-PA average particle diameter of the battery in Example 8 is described as “50 μm”. The Na-PA addition amount added to the battery in Example 8 is described as “1.5%/EL”. Namely, the battery of Example 8 is fabricated in such a way that 100 ppm/Zn of the polyethyleneimine ethoxylate is added to the anode 5 and to the electrolyte, and that only 1.5%/EL of the sodium polyacrylate with an average particle diameter of 50 μm is contained in the anode 5.

The additive to the battery in Example 9 is described as “polyethyleneimine ethoxylate”. The addition amount thereof added to the battery in Example 9 is described as “100 ppm/Zn”. The Na-PA average particle diameter of the battery in Example 9 is described as “120 μm”. The Na-PA addition amount added to the battery in Example 9 is described as “1.5%/EL”. Namely, the battery of Example 9 is fabricated in such a way that 100 ppm/Zn of the polyethyleneimine ethoxylate is added to the anode 5 and to the electrolyte, and that only 1.5%/EL of the sodium polyacrylate with an average particle diameter of 120 μm is contained in the anode 5.

The additive to the battery in Example 10 is described as “polyethyleneimine ethoxylate”. The addition amount thereof added to the battery in Example 10 is described as “100 ppm/Zn”. The Na-PA average particle diameter of the battery in Example 10 is described as “300 μm”. The Na-PA addition amount added to the battery in Example 10 is described as “1.5%/EL”. Namely, the battery in Example 10 is fabricated in such a way that 100 ppm/Zn of the polyethyleneimine ethoxylate is added to the anode 5 and to the electrolyte, and that only 1.5%/EL of the sodium polyacrylate with an average particle diameter of 300 μm is contained in the anode 5.

The additive to the battery in Example 11 is described as “polyethyleneimine ethoxylate”. The addition amount thereof added to the battery in Example 11 is described as “100 ppm/Zn”. The Na-PA average particle diameter of the battery in Example 11 is described as “500 μm”. The Na-PA addition amount added to the battery in Example 11 is described as “1.5%/EL”. Namely, the battery of Example 11 is fabricated in such a way that 100 ppm/Zn of the polyethyleneimine ethoxylate is added to the anode 5 and to the electrolyte, and that only 1.5%/EL of the sodium polyacrylate with an average particle diameter of 500 μm is contained in the anode 5.

The additive to the battery in Example 12 is described as “polyethyleneimine ethoxylate”. The addition amount thereof added to the battery in Example 12 is described as “100 ppm/Zn”. The Na-PA average particle diameter of the battery in Example 12 is described as “120 μm”. The Na-PA addition amount added to the battery in Example 12 is described as “0.7%/EL”. Namely, the battery of Example 12 is fabricated in such a way that 100 ppm/Zn of the polyethyleneimine ethoxylate is added to the anode 5 and to the electrolyte, and that only 0.7%/EL of the sodium polyacrylate with an average particle diameter of 120 μm is contained in the anode 5.

The additive to the battery in Example 13 is described as “polyethyleneimine ethoxylate”. The addition amount thereof added to the battery in Example 13 is described as “100 ppm/Zn”. The Na-PA average particle diameter of the battery in Example 13 is described as “120 μm”. The Na-PA addition amount added to the battery in Example 13 is described as “1.0%/EL”. Namely, the battery of Example 13 is fabricated in such a way that 100 ppm/Zn of the polyethyleneimine ethoxylate is added to the anode 5 and to the electrolyte, and that only 1.0%/EL of the sodium polyacrylate with an average particle diameter of 120 μm is contained in the anode 5.

The additive to the battery in Example 14 is described as “polyethyleneimine ethoxylate”. The addition amount thereof added to the battery in Example 14 is described as “100 ppm/Zn”. The Na-PA average particle diameter of the battery in Example 14 is described as “120 μm”. The Na-PA addition amount added to the battery in Example 14 is described as “1.5%/EL”. Namely, the battery of Example 14 is fabricated in such a way that 100 ppm/Zn of the polyethyleneimine ethoxylate is added to the anode 5 and to the electrolyte, and that only 1.5%/EL of the sodium polyacrylate with an average particle diameter of 120 μm is contained in the anode 5.

The additive to the battery in Example 15 is described as “polyethyleneimine ethoxylate”. The addition amount thereof added to the battery in Example 15 is described as “100 ppm/Zn”. The Na-PA average particle diameter of the battery in Example 15 is described as “120 μm”. The Na-PA addition amount added to the battery in Example 15 is described as “2.0%/EL”. Namely, the battery of Example 15 is fabricated in such a way that 100 ppm/Zn of the polyethyleneimine ethoxylate is added to the anode 5 and to the electrolyte, and that only 2.0%/EL of the sodium polyacrylate with an average particle diameter of 120 μm is contained in the anode 5.

The additive to the battery in Example 16 is described as “polyethyleneimine ethoxylate”. The addition amount thereof added to the battery in Example 16 is described as “100 ppm/Zn”. The Na-PA average particle diameter of the battery in Example 16 is described as “120 μm”. The Na-PA addition amount added to the battery in Example 16 is described as “2.5%/EL”. Namely, the battery of Example 16 is fabricated in such a way that 100 ppm/Zn of the polyethyleneimine ethoxylate is added to the anode 5 and to the electrolyte, and that only 2.5%/EL of the sodium polyacrylate with an average particle diameter of 120 μm is contained in the anode 5.

The result of the drop test corresponding to a certain battery sample among the results of the drop tests is obtained by performing the drop test with regard to this certain battery sample. In the drop test performed with regard to a certain battery sample, it is confirmed whether or not this certain battery sample is fabricated properly, in which this certain battery sample is dropped from 30 cm above a desk to obtain the pre-drop closed circuit voltage and the post-drop closed circuit voltage. The pre-drop closed circuit voltage represents the battery voltage of a battery sample when that battery sample is electrically connected to a 1Ω load for 0.3 seconds before it is dropped onto a desk. The post-drop closed circuit voltage represents the battery voltage of a battery sample when that battery sample is electrically connected to a 1Ω load for 0.3 seconds after it is dropped onto a desk. The result of the drop test corresponding to a certain battery sample among the results of the drop tests indicates the pre-drop closed circuit voltage minus the post-drop closed circuit voltage, or this is described as “unfabricable”. The results of the drop tests indicate that the battery sample corresponding to the drop test result with a value closer to 0 V has better resistances to a shock and a vibration. The battery sample corresponding to the drop test result described as “unfabricable” indicates that a proper fabrication fails due to a cause originating from the sodium polyacrylate.

Of the results of the drop tests, the drop test result corresponding to the battery in Comparative Example 4 is 0.00 V. Namely, the drop test results indicate that the battery not having polyethyleneimine ethoxylate added to the anode 5 or to the electrolyte has better resistances to a shock and a vibration.

Of the drop test results, the drop test result of the battery in Example 7 is 0.03 V, the drop test result of the battery in Example 8 is 0.01 V, the drop test result of the battery in Example 9 is 0.00 V, the drop test result of the battery in Example 10 is 0.00 V, and the drop test result of the battery in Example 11 is described as “unfabricable”.

The drop test results indicate that the batteries in Examples 7 to 10 were properly fabricated and that the battery in Example 11 was not properly fabricated. Namely, the drop test results indicate that the battery is properly fabricated when the sodium polyacrylate with an average particle diameter of 300 μm or less is contained in the anode 5. The drop test results further indicate that when the sodium polyacrylate with an average particle diameter of 500 μm or more is included in the anode 5, a defect occurs, so that the battery fails to be properly fabricated. An example of the defect is formation of many gelatinous grains that do not contain zinc powder thereby resulting in segregation of the zinc powder in the anode 5.

The drop test results indicate that the drop test result of the battery in Comparative Example 4 is closer to 0 V than the drop test results of the batteries in Examples 7 and 8. Namely, the drop test results indicate that the battery in which the polyethyleneimine ethoxylate is added to the anode 5 or to the electrolyte may have worse resistances to a shock and a vibration than the battery in which the polyethyleneimine ethoxylate is not added to the anode 5 or to the electrolyte.

The drop test results indicate that the drop test results of the batteries in Examples 8 to 10 are equivalent to the drop test result of the battery in Comparative Example 4. Namely, the drop test results indicate that the resistances to a shock and a vibration of the battery in which the sodium polyacrylate with an average particle diameter of 50 μm or more is included in the anode 5 is equivalent to the resistances to a shock and a vibration of the battery in which the polyethyleneimine ethoxylate is not added to the anode 5 or to the electrolyte.

The drop test results indicate that the drop test results of the batteries in Examples 8 to 10 are closer to 0 V than the drop test result of the battery in Example 7. Namely, the drop test results indicate that the batteries containing the sodium polyacrylate with an average particle diameter of 50 μm or more in the anode 5 have better resistances to a shock and a vibration than the battery containing the sodium polyacrylate with an average particle diameter of 30 μm or less in the anode 5.

The drop test results indicate that the drop test results of the batteries in Examples 9 to 10 are closer to 0 V than the drop test results of the batteries in Examples 7 to 8. Namely, the drop test results indicate that the batteries containing the sodium polyacrylate with an average particle diameter of 120 μm or more in the anode 5 have better resistances to a shock and a vibration than the batteries containing the sodium polyacrylate with an average particle diameter of 50 μm or less in the anode 5.

Of the drop test results, the drop test result of the battery in Example 12 is 0.04 V, the drop test result of the battery in Example 13 is 0.01 V, the drop test result of the battery in Example 14 is 0.00 V, the drop test result of the battery in Example 15 is 0.00 V, and the drop test result of the battery in Example 16 is described as “unfabricable”.

The drop test results indicate that the batteries in Examples 12 to 15 were properly fabricated and that the battery in Example 16 was not properly fabricated. Namely, the drop test results indicate that the battery is properly fabricated when the anode 5 contains 2.0% or less of the sodium polyacrylate relative to the electrolyte in the anode 5. The drop test results further indicate that when more than 2.5% of the sodium polyacrylate is present in the anode 5 relative to the electrolyte in the anode 5, a failure occurs and the battery is not properly fabricated. An example of the defect is that the anode 5 becomes so hard that the anode 5 is no longer charged inside the separator 7.

The drop test results indicate that the drop test result of the battery in Comparative Example 4 is closer to 0 V than the drop test results of the batteries in Examples 12 and 13 are. Namely, the drop test results indicate that the battery in which the polyethyleneimine ethoxylate is added to the anode 5 or to the electrolyte may have worse resistances to a shock and a vibration than the battery in which the polyethyleneimine ethoxylate is not added to the anode 5 or to the electrolyte.

The drop test results further indicate that the drop test results of the batteries in Examples 13 to 15 are comparable to the drop test result of the battery in Comparative Example 4. Namely, the drop test results indicate that the resistances to a shock and a vibration of the battery in which the addition amount of the sodium polyacrylate added to the anode 5 is 1.0%/EL or more is equivalent to the resistances to a shock and a vibration of the battery in which the polyethyleneimine ethoxylate is not added to the anode 5 or to the electrolyte.

The drop test results indicate that the drop test results of the batteries in Examples 13 to 15 are closer to 0 V than the drop test result of the battery in Example 12. Namely, the drop test results indicate that the batteries with an addition amount of the sodium polyacrylate of 1.0%/EL or more in the anode 5 have better resistances to a shock and a vibration compared to the battery with an addition amount of the sodium polyacrylate of 0.7%/EL or lower in the anode 5.

The drop test results indicate that the drop test results of the batteries in Examples 14 to 15 are closer to 0 V than the drop test results of the batteries in Examples 12 to 13. Namely, the drop test results indicate that the batteries with an addition amount of the sodium polyacrylate of 1.5%/EL or more in the anode 5 have better resistances to a shock and a vibration compared to the batteries with an addition amount of the sodium polyacrylate of 1.0%/EL or less in the anode 5.

### Effects of the Battery 1 of Embodiment

The battery 1 of the embodiment is provided with the cathode 3 containing manganese dioxide and graphite, the anode 5 containing zinc, the electrolyte in which the cathode 3 and the anode 5 are immersed, and the polyethyleneimine ethoxylate contained in the anode 5. Also, the battery 1 of the embodiment is provided with the cathode 3 containing manganese dioxide and graphite, the anode 5 containing zinc, the electrolyte in which the cathode 3 and the anode 5 are immersed, and the polyethyleneimine ethoxylate contained in the electrolyte. With these, the battery 1 of the embodiment may improve the discharge performance with a medium load.

Incidentally, the battery 1 of the above-mentioned embodiment has the polyethyleneimine ethoxylate added to both the anode 5 and the electrolyte, but one of the anode 5 and the electrolyte does not have to have the polyethyleneimine ethoxylate added. The battery 1 may improve the discharge performance with a medium load even when the polyethyleneimine ethoxylate is added to one of the anode 5 and the electrolyte.

The ratio of the mass of the polyethyleneimine ethoxylate to the mass of the zinc contained in the anode 5 of the battery 1 of the embodiment is 10 ppm or more and 10000 ppm or less. The discharge performance with a medium load of the battery 1 of the embodiment is better than the battery whose ratio is less than 10 ppm, and is better than the battery whose ratio is more than 10000 ppm.

The battery 1 of the embodiment is provided further with the sodium polyacrylate contained in the anode 5. The ratio of the mass of the sodium polyacrylate to the mass of the electrolyte contained in the anode 5 is 1.0% or more and 2.0% or less. The resistances of the battery 1 of the embodiment to a shock and a vibration are better than the battery whose ratio is less than 1.0%. The battery 1 of the embodiment may be properly fabricated compared to the battery whose ratio is more than 2.0%.

The average particle diameter of the sodium polyacrylate contained in the anode 5 of the battery 1 of the embodiment is 50 μm or more and 300 μm or less. The resistances of the battery 1 of the embodiment to a shock and a vibration are better than the battery whose average particle diameter is less than 50 μm. The battery 1 of the embodiment may be properly fabricated compared to the battery whose average particle diameter is more than 300 μm.

Incidentally, the anode 5 of the battery 1 described above contains the sodium polyacrylate, but a gelling agent other than the sodium polyacrylate may also be included. An example of the gelling agent like this is polyacrylic acid. Even when the gelling agent other than the sodium polyacrylate is included in the anode 5, the battery 1 may improve the discharge performance with a medium load by containing the polyethyleneimine ethoxylate in the anode 5 or in the electrolyte.

The battery discussed herein is allowed to improve the discharge performance.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A battery comprising:
a cathode that is containing manganese dioxide and graphite;
an anode that is containing zinc;
an electrolyte in which the cathode and the anode are immersed; and
a polyethyleneimine ethoxylate that is contained in the anode and in the electrolyte.

2. The battery according to claim 1, wherein a ratio of a mass of the polyethyleneimine ethoxylate to a mass of the zinc is 10 ppm or more and 10000 ppm or less.

3. The battery according to claim 2, further comprising:
a sodium polyacrylate that is contained in the anode; and
another electrolyte that is contained in the anode, wherein
a ratio of a mass of the sodium polyacrylate to a mass of the another electrolyte is 1.0% or more and 2.0% or less.

4. The battery according to claim 2, further comprising a sodium polyacrylate that is contained in the anode, wherein
an average particle diameter of the sodium polyacrylate is 50 μm or more and 300 μm or less.

5. The battery according to claim 2, further comprising:
a sodium polyacrylate that is contained in the anode; and
another electrolyte that is contained in the anode, wherein
a ratio of a mass of the sodium polyacrylate to a mass of the another electrolyte is 1.0% or more and 2.0% or less, and
an average particle diameter of the sodium polyacrylate is 50 μm or more and 300 μm or less.

6. A battery comprising:
a cathode that is containing manganese dioxide and graphite;
an anode that is containing zinc;
an electrolyte in which the cathode and the anode are immersed; and
a polyethyleneimine ethoxylate that is contained in the anode.

7. The battery according to claim 6, wherein a ratio of a mass of the polyethyleneimine ethoxylate to a mass of the zinc is 10 ppm or more and 10000 ppm or less.

8. The battery according to claim 7, further comprising:
a sodium polyacrylate that is contained in the anode; and
another electrolyte that is contained in the anode, wherein
a ratio of a mass of the sodium polyacrylate to a mass of the another electrolyte is 1.0% or more and 2.0% or less.

9. The battery according to claim 7, further comprising a sodium polyacrylate that is contained in the anode, wherein
an average particle diameter of the sodium polyacrylate is 50 μm or more and 300 μm or less.

10. The battery according to claim 7, further comprising:
a sodium polyacrylate that is contained in the anode; and another electrolyte that is contained in the anode,
wherein
a ratio of a mass of the sodium polyacrylate to a mass of the another electrolyte is 1.0% or more and 2.0% or less, and
an average particle diameter of the sodium polyacrylate is 50 μm or more and 300 μm or less.

11. A battery comprising:
a cathode that is containing manganese dioxide and graphite;
an anode that is containing zinc;
an electrolyte in which the cathode and the anode are immersed; and
a polyethyleneimine ethoxylate that is contained in the electrolyte.

12. The battery according to claim 11, wherein a ratio of a mass of the polyethyleneimine ethoxylate to a mass of the zinc is 10 ppm or more and 10000 ppm or less.

13. The battery according to claim 12, further comprising:
a sodium polyacrylate that is contained in the anode; and
another electrolyte that is contained in the anode, wherein
a ratio of a mass of the sodium polyacrylate to a mass of the another electrolyte is 1.0% or more and 2.0% or less.

14. The battery according to claim 12, further comprising a sodium polyacrylate that is contained in the anode, wherein
an average particle diameter of the sodium polyacrylate is 50 μm or more and 300 μm or less.

15. The battery according to claim 12, further comprising:
a sodium polyacrylate that is contained in the anode; and another electrolyte that is contained in the anode,
wherein
a ratio of a mass of the sodium polyacrylate to a mass of the another electrolyte is 1.0% or more and 2.0% or less, and
an average particle diameter of the sodium polyacrylate is 50 μm or more and 300 μm or less.
